(19) United States
(12) Patent Application Publication
(10) Pub. No.: US 2019/0004403 A1
(43) Pub. Date: Jan. 3, 2019

(54) Contoured Airfoil Payload Stabilizer

(71) Applicant: Vance Burberry, Playa Del Rey, CA (US)

(72) Inventor: Vance Burberry, Playa Del Rey, CA (US)

(21) Appl. No.: 16/111,202

(22) Filed: Aug. 23, 2018

Related U.S. Application Data
(63) Continuation-in-part of application No. 15/608,644, filed on May 30, 2017, now abandoned.

(51) Int. Cl. G03B 17/56; G03B 17/08

(52) U.S. Cl. CPC G03B 17/561; G03B 17/08

(57) ABSTRACT

A buoyant airfoil stabilization platform that can compensate for fluid flow above, below, and around an attached payload. The airfoil stabilization platform being a delta-winged airfoil that has a substantially, elliptical cross section. In an alternative embodiment, the airfoil stabilization platform is a linear shaped airfoil having pillar mounted left and right wings. The airfoil uses fluid dynamics principles to assist in the stability of a mounted payload. The airfoil stabilization platform also comprises a payload mount and a handle grip. The payload mount is designed to receive camera, lighting, sonar, and other devices. The handle grip allows the user to control and assist in the stabilization of the platform. The handle grip can further contribute to the stabilization of the platform by including components for allowing the center of gravity or buoyancy of the apparatus to be adjusted.

### CROSS-REFERENCE TO RELATED APPLICATIONS

This application is a continuation-in-part of application Ser. No. 15/608,644, filed May 30, 2017.

### FIELD OF THE INVENTION

The invention relates to a stabilized platform for supporting devices underwater including cameras, sonar, telescopic lenses, antennas, and other devices. More particularly, the invention relates to a self-leveling, stabilized platform for mounting cameras in underwater applications.

### BACKGROUND OF THE INVENTION

When using cameras in underwater applications it is often necessary for the camera to be stabilized in some manner. The push and pull of an ocean, river, lake, or water currents in general, makes it very difficult to capture stable images while the camera is submerged in water. Prior art systems include hand held camera mounts which relied on the physical strength of the photographer to hold the camera platforms stable and were not designed to compensate for the fluid dynamics associated with underwater currents.

It is often desirable in underwater photography or videography to submerge a camera encased in a water proof apparatus that is mounted to a handle so that it can be held and controlled by a photographer or videographer. In such instances the submerged camera may be slowly moved through the water above the seabed, riverbed, lakebed, or ocean bottom (herein after, ocean bottom). The camera movement can also be stopped so that the camera can be positioned adjacent to an object being viewed. The weight of such a submerged camera in water may be relatively small and, in many instances, may be only a few ounces. Such an effective, light-weight camera attached to a hand-held mount is readily subject to undesirable movement caused by underwater currents, motion of passing sea life, or motion caused by non-uniform, irregular changes in tension applied to the hand-held mount by the user. The light-weight of the camera may also offset the center of gravity of the camera mount, causing it shift up or down in response to the currents. Terrain conditions at the ocean bottom may also affect movement of the camera.

It will be apparent that under such conditions as mentioned above, that the picture captured by the camera will rarely be a steady picture capable of being carefully studied and examined because of the uncertain irregular movement of the camera in the water. Prior proposed means for stabilizing an underwater camera have included various devices that focused on the handles that the user held to support the camera. Such prior proposed stabilizing devices included several disadvantages in that the user's movements also contributed to stabilization problems with the camera. The handles also added bulkiness and weight which shifted the center of gravity of the apparatus under water. These prior art devices did not solve the problem of stabilizing the camera platform, which is critical for capturing useful footage and images.

Stability issues may arise when a camera is operated underwater, where disturbances such as operator movement and currents, can cause the camera to shake or move producing bad image quality. The principal degrees of freedom which cause bad image quality has been identified as roll, pitch, yaw and vertical translation, but may also include forward and lateral translation.

A passive stability system is proposed where a lifting surface is used to dampen disturbances in any of the degrees of freedom of the system. The lifting surface may be optimized for one or more of the identified degrees of freedom via choice of airfoil and platform, as well as position relative to the camera. Standard practices of aircraft design may dictate the design of the lifting surface as well as hydrofoil design.

The present invention meets one or more of the above-referenced needs as described herein in greater detail.

### SUMMARY OF THE INVENTION

The present invention contemplates a novel construction of a stabilizing device for a submerged body, particularly an exemplary camera body, wherein the camera is both stabilized (that is, irregular motion eliminated or reduced to a minimum) in its movement through the water and is stabilized when it comes to a position of rest or immobility either on the seabed, riverbed, lakebed, or ocean bottom (herein after, ocean bottom) or at a selected spaced, distance above the ocean bottom. The stabilizing device of the present invention contemplates a simple effective structure, which has been found to effectively steady a submerged camera body against water currents and to compensate for changes in the center of gravity when the camera and stabilization platform are submerged.

In an embodiment, the present invention contemplates a stabilizing device which may be readily attached to the camera body and which, can include a buoyant, swept back, contoured delta-winged airfoil member that has a substantially, elliptical cross section. The airfoil member has leading and trailing edges of varying dimensions to allow for fluid dynamic principles to assist in the stability of the stabilizing platform, and thus, the stability of the camera. The airfoil member having a lower surface with a handle receptacle along the center line of the root of the airfoil member for securing the airfoil member to a proximal end of a tubular member. The tubular member having a distal end with a handle grip so that it can be held and controlled by a user. An upper surface of the airfoil member comprising a camera mounting receptacle along the center line of the root of the airfoil member for securing a mounted camera. The airfoil member may further comprise winglets at each of its distal ends so that adequate lateral and longitudinal stability will be imparted to the camera body, not only as the camera body moves through the water, but also when the camera body is held at rest at a selected depth. Briefly described, aspects of the present invention include the following.

In a first aspect of the present invention a stabilization platform that is capable of compensating for fluid flow above, below, and around an attached camera system or other payload is described. The portable airfoil-based payload stabilizer comprises a swept back, contoured, delta-winged airfoil member that has a substantially, elliptical cross section. The airfoil member has a bottom or lower surface with an attached handle receptacle along the center line of the root of the airfoil member. The handle receptacle secures the airfoil member to a proximal end of a handle member. The top or upper surface of the airfoil member comprises an attached payload mounting receptacle along the center line of the root of the airfoil member for securing a mounted payload.

Further within the first aspect of the present invention, the handle member further comprises a tubular shape and a first grip secured at a distal end of the handle member and a receptacle attachment at a proximal end of the handle member. In a further aspect of the present invention, the tubular shaped handle member comprises an enclosed cylinder that is 60-90% filled with a viscous fluid for dynamically changing the center of gravity of the portable airfoil-based payload stabilizer. In still a further aspect of the present invention, the tubular shaped handle member comprises an enclosed cylinder that is 60-90% filled with water for dynamically changing the buoyancy of the portable airfoil-based payload stabilizer. In an even further aspect of the present invention, the tubular shaped handle member is mounted at swept back angle of 1-89 degrees relative to the airfoil member, allowing it to compensate for the center of gravity of the portable airfoil-based payload stabilizer. In still a further aspect of the invention, the tubular shaped handle member is capable to receiving additional weight components for adjusting the center of gravity of the portable airfoil-based payload stabilizer.

In a second aspect of the present invention, the delta winged, airfoil member is neutrally buoyant and water submergible. In a further aspect of the present invention, the delta winged, airfoil member is positively buoyant and water submergible. In a still further aspect of the present invention, the airfoil member can receive external, counter balancing weights along the upper or lower surface of the airfoil member. In a still further aspect of the present invention, winglets are attached at each distal end of the airfoil member. In still a further aspect of the present invention, the winglets are removable and flexibly attached to the distal ends of the delta wing, airfoil member. In a further aspect of the present invention, the winglets comprise a lighting device along a leading or trailing edge of the winglets. In another aspect of the present invention, the winglets comprise a detachable lighting device pod along a leading or trailing edge of the winglets. In another aspect of the present invention, the winglets may be upward or downward biased.

In a third aspect of the present invention, the payload mounting receptacle is motorized to allow 360-degree rotation of the mounted payload via a control. In a further aspect of the present invention, the portable airfoil payload stabilizer incorporates a wired or wireless connection to a mounted payload for remote operation of cameras, lights, the payload mounting receptacle, or other features.

In a fourth aspect of the present invention a portable camera stabilizer that is capable of compensating for fluid flow above, below, and around an attached camera system is described. The portable camera stabilizer comprises a swept back, delta winged, airfoil member. The airfoil member has a bottom lower surface with an attached handle receptacle along the center line of the root of the airfoil member for securing the airfoil member to a proximal end of a handle member. The airfoil member also has a top upper surface with a camera mounting receptacle attached along a center line of the root of the airfoil member for securing a mounted camera.

In a fifth aspect of the present invention, the delta winged, airfoil member is neutrally buoyant and water submergible. In a further aspect of the present invention, the delta winged, airfoil member is positively buoyant and water submergible. In a still further aspect of the present invention, the airfoil member can receive external, counter balancing weights along the upper or lower surface of the airfoil member. In a still further aspect of the present invention, winglets are attached at each distal end of the airfoil member. In still a further aspect of the present invention, the winglets are removable and flexibly attached to the distal ends of the delta wing, airfoil member. In a further aspect of the present invention, the winglets comprise a lighting device along a leading or trailing edge of the winglets. In another aspect of the present invention, the winglets comprise a detachable lighting device pod along a leading or trailing edge of the winglets. In another aspect of the present invention, the winglets may be upwardly or downwardly biased.

In a Sixth embodiment, a portable camera stabilizer, comprising right and left wings mounted atop a proximal end of respective right and left pillars is described. The right and left pillars are attached at opposite ends respectively of a linear payload base. One or more handles are mounted along the linear payload base. A camera mounting receptacle is also mounted along the linear payload base for securing a mounted camera.

The above features as well as additional features and aspects of the present invention are disclosed herein and will become apparent from the following description of preferred embodiments of the present invention.

This summary is provided to introduce a selection of aspects and concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings, exemplary constructions of the embodiments; however, the embodiments are not limited to the specific methods and instrumentalities disclosed. In the drawings:

FIG. 1 is a forward view of the airfoil payload stabilizer and attached handle;

FIG. 2 is a top down view of the airfoil payload stabilizer with a mounted camera payload attached;

FIG. 3 is a rearward view of the airfoil payload stabilizer with a mounted camera payload attached and attached handle;

FIG. 4 is a bottom-up view of the airfoil payload stabilizer and attached handle;

FIG. 5 is a side view, right to left planar perspective of the delta wing airfoil with a mounted camera payload attached and attached handle;

FIG. 6 is a rear, right to left planar perspective of the delta wing airfoil with a mounted camera payload attached and attached handle;

FIG. 7 is a side view of the delta wing airfoil with a mounted camera payload attached and attached handle;

FIG. 8 is a front perspective view of a linear airfoil stabilizer;

FIG. 9 is an alternative embodiment of a high-wing, linear airfoil stabilizer;

FIG. 10 is a forward and side perspective view of a high-wing, linear airfoil stabilizer;

FIG. 11 is a side perspective view of a high-wing, linear airfoil stabilizer;

FIG. 12 is a top down perspective view of a high-wing, linear airfoil stabilizer;

FIG. 13 is an alternative embodiment of a low-wing, linear airfoil stabilizer;

FIG. 14 is a forward and side perspective view of a low-wing, linear airfoil stabilizer;

FIG. 15 is a side perspective view of a low-wing, linear airfoil stabilizer;

FIG. 16 is a top down perspective view of a low-wing, linear airfoil stabilizer;

FIG. 17 is a forward view of alternative embodiment of a handle-wing, linear airfoil stabilizer;

FIG. 18 is a forward and side perspective view of a handle-wing, linear airfoil stabilizer;

FIG. 19 is a side view of a handle-wing, linear airfoil stabilizer; and

FIG. 20 is a top down perspective of a handle-wing, linear airfoil stabilizer.

### DETAILED DESCRIPTION

Before the present device, methods and systems are disclosed and described in greater detail hereinafter, it is to be understood that the devices, methods and systems are not limited to specific devices, methods, specific components, or particular implementations. It is also to be understood that the terminology used herein is to describe particular aspects and embodiments only and is not intended to be limiting.

As used in the specification and the appended claims, the singular forms “a,” “an” and “the” include plural referents unless the context clearly dictates otherwise. Similarly, “optional” or “optionally” means that the subsequently described feature or component may or may not be included, and the description includes instances where the feature or component is included and instances where it is not included.

Throughout the description and claims of this specification, the word “comprise” and variations of the word, such as “comprising” and “comprises,” mean “including but not limited to,” and is not intended to exclude, for example, other components, integers or steps. “Exemplary” means “an example of” and is not intended to convey an indication of preferred or ideal embodiment. “Such as” is not used in a restrictive sense, but for explanatory purposes.

Disclosed are components that can be used to perform the disclosed device, methods, and systems. These and other components are disclosed herein, and it is understood that when combinations, subsets, interactions, groups, etc. of these components are disclosed that while specific reference to each various individual and collective combinations and permutations of these cannot the explicitly disclosed, each is specifically contemplated and described herein, for all device, methods, and systems. This applies to all aspects of this specification including, but not limited to, combinations of described device components. Thus, if there are a variety of component combinations that can be assembled with the base airfoil device, it is understood that each of the additional component combinations may be used with any of the specific embodiments or combination of embodiments of the disclosed device.

As will be appreciated by one skilled in the art, the methods and systems may take the form of an entirely new hardware embodiment, an entirely new software embodiment, or an embodiment combining new software and hardware aspects. References are made herein to the attached drawings. Like reference numerals are used throughout the drawing to depict like or similar elements of the airfoil payload stabilizer for a camera and camera accessories. For the purposes of presenting a brief and clear description of the present invention, the preferred embodiment will be discussed as a payload stabilizer used to mount a camera and camera accessories while diving underwater. The figures are intended for representative purposes only and should not be construed to be limiting in any aspect.

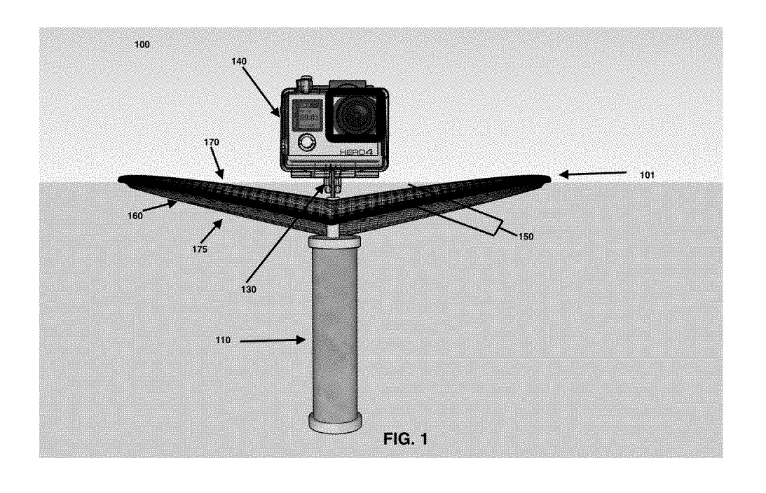

Referring now to FIG. 1, there is shown a forward view of an airfoil stabilization platform 100. The airfoil stabilization platform 100 consists largely of a di-hederal, delta-winged airfoil that has a substantially, contoured, elliptical cross-section 101 with a mounted camera or other payload 140 attached on an upper airfoil surface 170 and an attached handle 110 mounted on a lower airfoil surface 175. The delta-winged shaped airfoil has a contoured, substantially three-dimensional, elliptical cross section (herein after, the airfoil) 101. The high point of the convex is 0.5-50 degrees higher than the leading edge 150. Similarly, the low point of the concave is 0.5-50 degrees lower than the leading edge 150. In a preferred embodiment, the convex curve along the upper airfoil surface 170, provides downward pressure on the airfoil stabilization platform 101, while the concave curve along the lower airfoil surface 175 provides upward pressure on the airfoil stabilization platform 101, the counter pressures thereby, increases the stability of the entire airfoil stabilization platform 101. The airfoil 101 comprises a leading edge 150 that is substantially curved to allow fluid flow above and below the airfoil 101. In an embodiment, the leading edge 150 substantially flows into a convex upper airfoil surface 170 to allow fluid flow above the airfoil. In another embodiment, the leading edge 150 substantially flows into a concave lower airfoil surface 175 to allow fluid flow above the airfoil. In a further embodiment, the leading edge 150 substantially flows into a concave or convex lower airfoil surface 175 to allow fluid flow below the airfoil. In another embodiment, the leading edge 150 substantially flows into a concave or flat upper airfoil surface 175 to allow fluid flow above the airfoil. The airfoil 101 further comprises a trailing edge 160, that tapers to allow fluid to flow pass from the airfoil 101. On the upper airfoil surface 170, a mounting receptacle 130 can accept a camera or other payload 140. Along the lower airfoil surface 175, the handle 110 is mounted.

The airfoil 101 further comprises a buoyant material to offset the negative buoyancy of an attached payload 140. In addition, in an embodiment, the angle of attack of the leading edge 150 is 5 to 15 degrees positive to further add stability to the airfoil stabilization platform 100.

The center of mass of the airfoil stabilization platform 100, relative to the aerodynamic center or center of pressure of the airfoil 101 plays a significant role in the stability of the system. This has to be treated for all three axes: forward, lateral and vertical. The lateral placement of the center of mass is the most obvious. For a steady level “flight” of an attached payload 140, this should be centered along the airfoil 101 symmetry plane.

In the case of a wing-tail configuration, stable conditions can be achieved by placing the center of mass (or the payload 140) behind the quarter chord position. Ideally, this will be located between 25-30% of the chord. Therefore, the payload 140 and handle 110 mounting positions along the airfoil 101 are important to ensure stability. This can be achieved by moving the airfoil 101 forwards or backwards relative to the payload 140.

Stability of the payload 140 is assured if the center of mass is located correctly in the vertical axis. For vertical placement the keel effect (pendulum effect), where the center of mass is located below the center of pressure to provide righting moment when the airfoil stabilization platform 100 is offset from steady condition. This can be achieved by placing the airfoil 101 “wings” in a higher position relative to the payload 140. Alternatively, a lower contouring of the airfoil 140 “wings” relative to the payload 140 can be placed if sufficient ballast is placed underneath it to offset the center of mass of the airfoil stabilization platform 100 assembly.

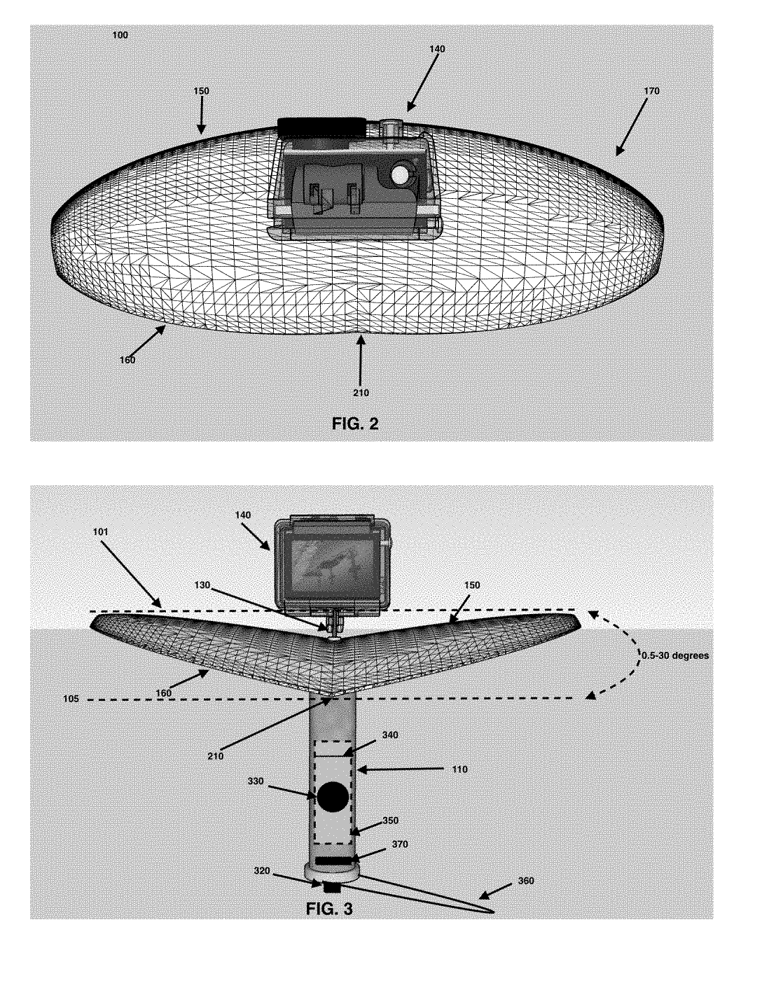

Referring now to FIG. 2, on the upper surface 170 of the airfoil 101, along the center line 210 of the root of the airfoil 100 comprises the mounting receptacle 130 (not visible in this figure) and camera/payload 140.

Referring now to FIG. 3, a rearward view of airfoil stabilization platform 100. The delta winged shaped airfoil stabilization platform that has an elliptical cross section 101. Along the lower surface of the airfoil 101, the handle 110 is mounted. The handle 110 can be mounted along the centerline 210 of the airfoil 101, or it can be mounted offset to the centerline 210 of the airfoil 101. In an embodiment, the upper surface of the airfoil 170 is a convex curve that arcs from the leading edge 150 at the front of the airfoil 101 and down to the trailing edge 160 at the rear of the airfoil 101. In a further embodiment, the lower surface of the airfoil is a concave curve that arcs from leading edge 150 at the front of the airfoil 101 and up to the trailing edge 160 at the rear of the airfoil 101. In a still a further embodiment, the lower surface of the airfoil is a convex curve that arcs from leading edge 150 at the front of the airfoil 101 and up to the trailing edge 160 at the rear of the airfoil 101. Further along the upper surface of the airfoil 101, a payload mounting receptacle 130 is placed along a center line 210 of the airfoil 101. The payload mounting receptacle 130 can receive a camera or other payload 140.

In a further embodiment, referencing FIG. 5 along a center line 210 the airfoil 101, may also comprise substantially contoured, “butterfly” dihedral wings. The dihedral wings lower the center of gravity and increases stability by reducing roll, pitch, yaw, and lateral translation. The substantially contoured, “butterfly” dihedral delta wings comprising right 510 and left 520 halves of the airfoil 101. Each of the right 510 and left 520 halves of the airfoil 101 can be biased upward 0.5 to 30 degrees from the horizontal baseline 530 of the airfoil 101 to an upper terminus 540 of the airfoil 101. Furthermore, each of the right 510 and left 520 halves of the airfoil 101 can swept backwards from the leading edge 150 of the front center line 210 of the airfoil 101 from 0.5 to 30 degrees to the rear terminus 550 of the airfoil. In an embodiment, the cross section 560 of the airfoil 101 is substantially a contoured “comma” or “tear-drop” shaped with a convex upper airfoil surface 170 and a concave lower airfoil surface 175. In an alternative embodiment, the cross section 560 of the airfoil 101 is substantially a contoured, elliptical -shaped with a convex upper airfoil surface 170 and a convex or concave lower airfoil surface 175. On either side of the centerline 210 of the airfoil 101, each of the “butterfly” shaped wings comprising right 510 and left 520 halves of the airfoil 101 can be fixed, flexible, or detachably attached.

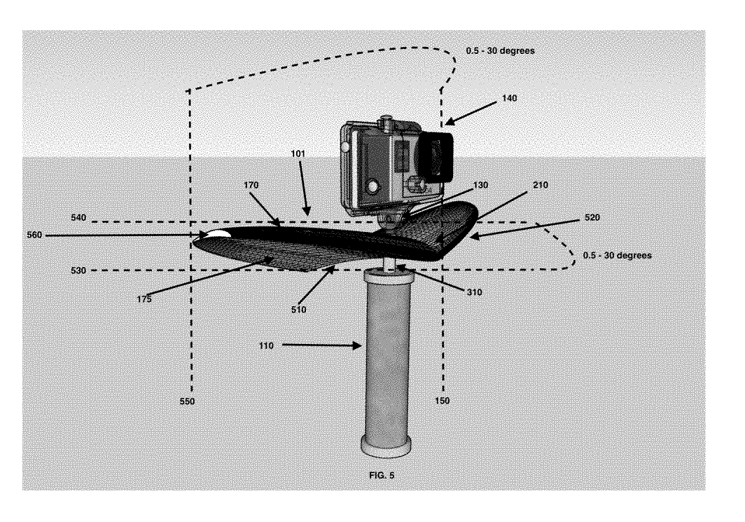

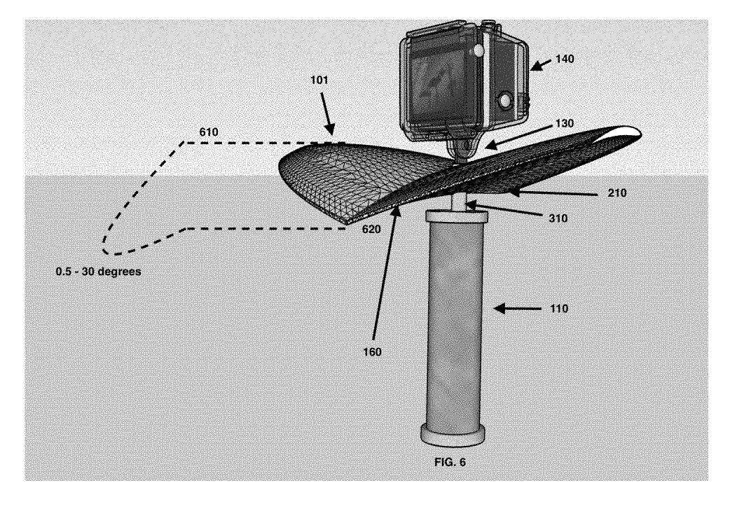

Referencing FIG. 6, a rearward, right to left planar perspective of the airfoil 101 with a mounted camera or payload 140 attached to the payload receptacle 130 and an attached handle receptacle 310 attached to the handle 110. In an embodiment, shown this perspective, the convex upper surface 170 of the airfoil 101 tapers up and over the convex curve from the centerline 210 and downward 0.5 to 30 degrees toward the rear of the airfoil 101 off to the trailing edge 160. The handle receptacle 310 is designed to receive the handle 110 that the user grasp to hold the airfoil stabilization platform 101 and attached payload 140 in place. The handle receptacle 310 may allow for fixed, flexible, or detachable handles 110.

In still a further embodiment, referencing FIG. 3, the handle 110 is substantially a hollow tube 350. The hollow tube 350 handle 110 can be filed with adjustable volumes of air, water, or other viscous fluids 340 to adjust the buoyancy and/or center of gravity of the airfoil stabilization platform 100. In an embodiment, the enclosed hollow tube 350 handle 110 can contain 60-90% viscous fluid 340 for dynamically changing the center of gravity of the airfoil stabilization platform 100. In a further embodiment weights 330 may be inserted into the hollow tube 350 handle 110 to adjust the buoyancy and center of gravity the airfoil stabilization platform 100. The weights 330 can also float in the viscous fluid 340 to further dynamically adjust the center of gravity of the airfoil stabilization platform 100. In another embodiment, additional external weights 320 can be attached to the handle to further adjust the center of gravity and buoyancy of the airfoil stabilization platform 101. Furthermore, the handle 100, can be covered in rubber, made of ruff metal, plastic, or an otherwise grip-able material 350, thereby allowing the airfoil stabilization platform 100 to easily be grasped underwater. In an embodiment, the handle 110 can include a leash 360 to prevent the airfoil stabilization platform 100 from floating away from the user. In another embodiment, the handle 110 can contain electronic features 370 such as lighting, batteries, gyroscopes, radio frequency and Bluetooth radios. The handle 110 can include controls electronically or mechanically connected to the mounting receptacle 130 to allow the payload 140 to rotate up to 360 degrees.

Turning now to FIG. 7, the handle 110, is attached to the airfoil 101. The contour of the airfoil 101 arcs from the leading edge 210 in convex fashion over the upper surface 170 of the airfoil 101 and then taper offs toward the rear trailing edge 160 of the airfoil 101. Along the lower surface 175 of the airfoil 101 in a concave fashion towards the rear trailing edge 160 of the airfoil. In a cross section 560 the airfoil 101 is substantially “tear-dropped” or “comma” shaped wherein on either side of the centerline 210 of the airfoil 101, each of the “butterfly” shaped wings comprising right 510 and left 520 halves of the airfoil 101 can be fixed, flexible, or detachably attached.

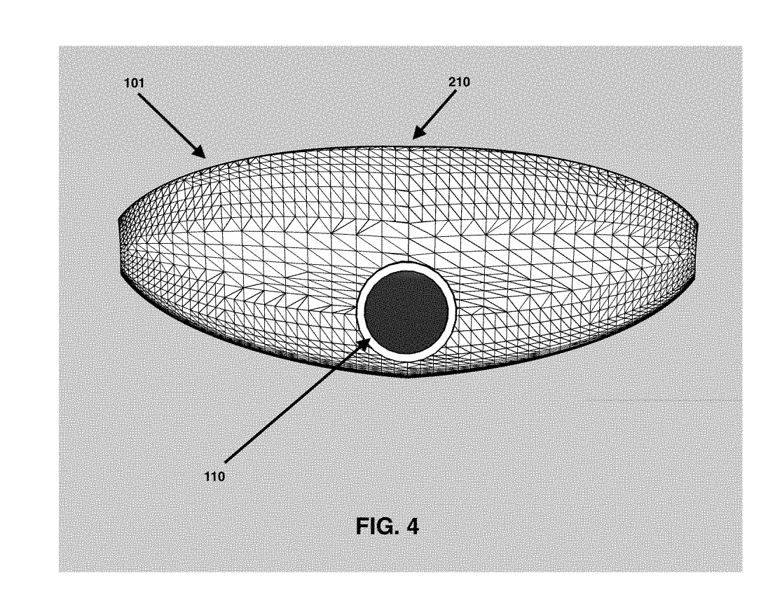

Further in FIGS. 4-7, in a further embodiment, the upper terminal edges of the winglets 120 can hold one or more pods 590. Pods 590 can contain lights, LEDs, cameras, underwater flash, lasers, sonar, or other equipment for assisting the user with underwater work. The Pods 590 can be fixed, flexible, or detachably attached to the upper terminal edges of the airfoil 101. In still another embodiment the Pods 590 can be fixed, flexible, or detachably attached to distal, terminal edges of the airfoil 101. Furthermore, in an embodiment, the Pods 590, may comprise a buoyant material to further increase stability of the airfoil stabilization platform 100.

Turning now to FIG. 7, in an embodiment, the airfoil stabilization platform 100 can comprise individual right 510 and left 520 halves of the airfoil 101, that attach to a base handle receptacle 710 (herein after base 710) along the center line 210. The base 710 can comprise attaching to a payload mounting receptacle 130 for receiving a camera and/or other payload equipment 140. On either the left or right sides of the base 710, each of the “butterfly” shaped wings comprising right 510 and left 520 halves of the airfoil 101 can fixed, flexible, or detachably attached. Furthermore, pods 580 can be fixed, flexible, or detachably attached to the right 510 and left 520 halves of the airfoil 101 wings 510, 520. Wings 510 and 520 can move independently of each other to adjust for fluid flow while still providing buoyancy and stability.

FIG. 8 illustrates a further embodiment of the airfoil stabilizer 810. Here the airfoil stabilizer 810 is substantially linear in shape. In the case of an underwater camera setup, payload 140 components may be added depending on operator choice. Components such as lights are fastened or joined to the top of the camera payload 140. An airfoil 101 having “high-contoured wings” or lifting surface position would interfere with these components. Therefore, the airfoil stabilization platform 101 or “lifting surface” can be split in two and the airfoil 101 “wings” can be positioned in more outboard positions, effectively increasing the span of the linear base 895 of lifting surface. This effectively avoids any interference with additional components mounted centrally with the camera payload 140.

The linear airfoil stabilizer 810, comprises a linear base 895 upon which the associated components are mounted. The linear airfoil stabilizer 810 allows for high-mounted lifting surface or right 820 and left 830 airfoil wings which provide stability, but do not interfere with the placement of additional components on a payload mount 840. The high-mount of the right 820 and left 830 airfoil wings are achieved by placing pillars 880 along the right and left sides of the linear base 895. These pillars 880 provide structural stability but may also provide aerodynamic/hydrodynamic benefits. These struts may be simple structures or profiled to act as lifting surfaces, such as to provide directional stability.

The right 820 and left 830 wings have a front leading edge 850 and a rear trailing edge 860 to manage fluid flow. In an embodiment, each of the contoured “tear drop or comma-shaped” right 820 and left 830 wings of the airfoil stabilizer platform 810 can be fixed, flexible, or detachably attached. This fixed or flexible attachment allows the operator to change the angle of attack or orientation of the lifting surface. This would provide benefits in fluid mechanics and stability.

Along a side or lower surface of the left 830 and right 820 wings, the pillars 880 are attached along the linear base 895. Along an upper surface of the linear base 895, a payload mount 840 is attached. The payload mount 840 is bracketed by handles 870 that substantially form a “U” shaped grip along the linear base 895. The “U” shaped grip is created by the handles 870 bracketing on either side of an attached payload 840. A camera 840 (or other payload) can be mounted between the “U” shaped handles 870 and along the linear base 895. The airfoil stabilizer platform 810 can further comprise one or more attached handle(s) 870 along a lower surface of the airfoil stabilizer 810.

Further in an embodiment, the airfoil stabilizer 810, “tear drop or comma” shaped wings comprising right 820 and left 830 halves of the airfoil stabilizer platform 810 are attached to the airfoil stabilizer platform 810 via a plurality of pillars 880. Each of the pillars 880 has a forward-facing leading edge and rearward facing trailing edge to manage fluid flow.

The handles of the payload mount 890 allows the user to control the linear airfoil stabilizer 810. In a further embodiment, the handles 110, 870 on both the linear 810 and the butterfly airfoil stabilizer platform 100 can be mounted at a fixed angle or an adjustable tilt angle via a mounting receptacle 130, 890 to the airfoil 101, 810. In another embodiment, the airfoil stabilization platform 100 has two or more support handles 110 mounted along a lower surface of the airfoil 100 via mounts 130.

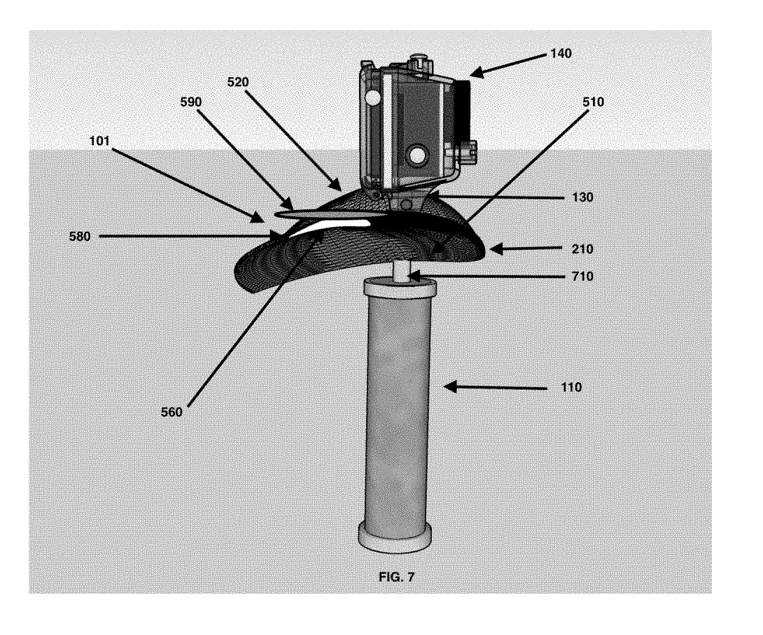

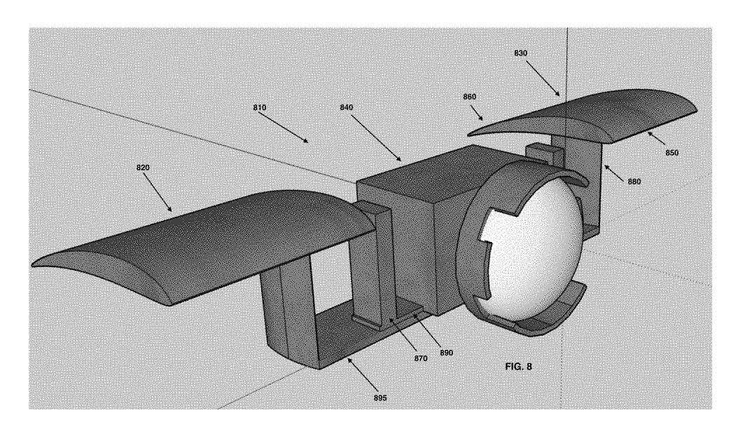

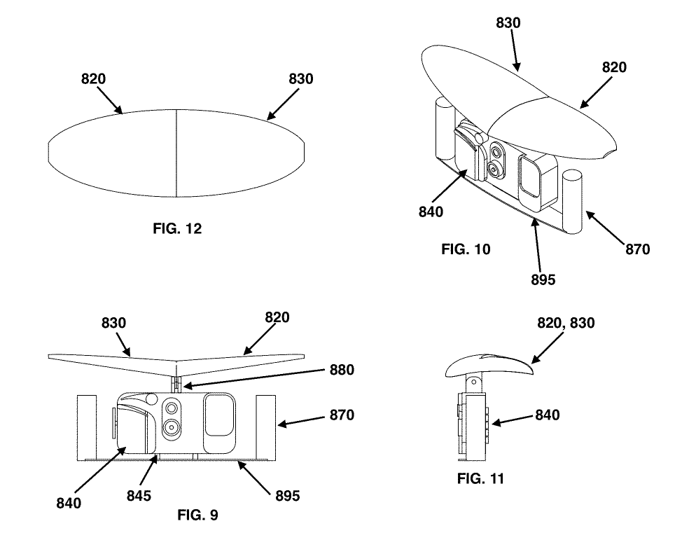

FIGS. 9-12 illustrate further embodiments of a high-wing, linear airfoil stabilizer 810. For example, in FIG. 9, the right 820 and left 830 wings are mounted on a single pillar 880, attached to the linear base 895. Handles 870 are also attached to the line base 895 and bracket the payload 840. The payload 840 is mounted on a payload mounting receptacle 845, that is attached to the linear base 895.

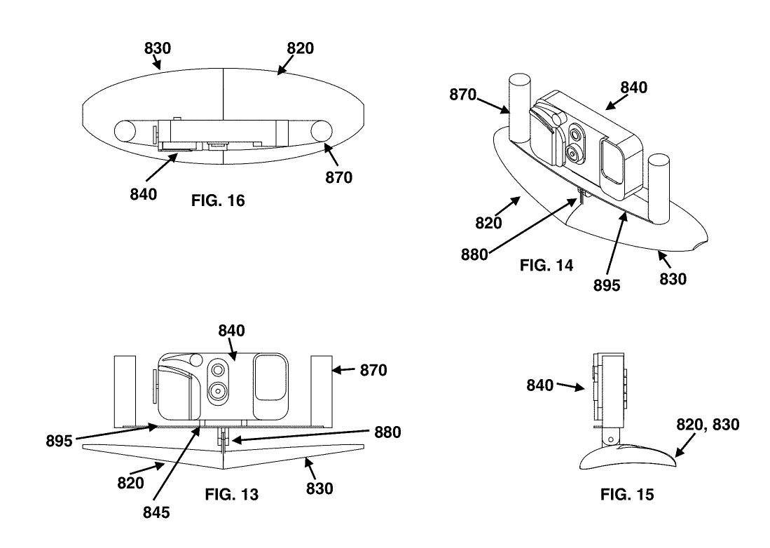

FIGS. 13-17 illustrate further embodiments of a low-wing, linear airfoil stabilizer 810. For example, in FIG. 13, the right 820 and left 830 wings are mounted on a single pillar 880, attached to the linear base 895. Handles 870 are also attached to the line base 895 and bracket the payload 840. The payload 840 is mounted on a payload mounting receptacle 845, that is attached to the linear base 895.

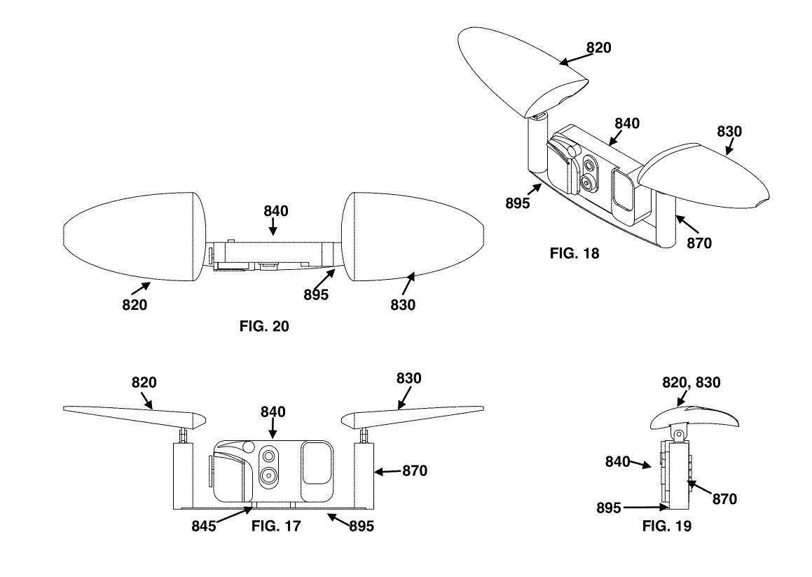

FIGS. 17-20 illustrate further embodiments of a handle-mounted-wing, linear airfoil stabilizer 810. For example, in FIG. 17, the right 820 and left 830 wings are mounted atop the handles 870, attached to the linear base 895. In an alternative embodiment, the right 820 and left 830 wings are mounted to the bottom of the handles 870. Attaching the wings to the Handles 870 reduce weight and manufacturing costs. Handles 870 are also attached to the line base 895 and bracket the payload 840. The payload 840 is mounted on a payload mounting receptacle 845, that is attached to the linear base 895.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A portable airfoil-based payload stabilizer, comprising:
a swept back, contoured delta-winged airfoil member that has a substantially, elliptical cross section;
the airfoil member having a lower surface with an attached handle receptacle member;
a handle member attached to the handle receptacle member for securing the airfoil member to a proximal end of the handle member;
and a payload mounting receptacle, mounted along an upper surface of the airfoil member, for securing a mounted payload.

2. The portable airfoil payload stabilizer according to claim 1, wherein the handle member further comprises a tubular shape and a first grip secured at a distal end of the handle member and a receptacle attachment at a proximal end of the handle member.

3. The portable airfoil payload stabilizer according to claim 2, wherein the tubular handle member comprises an enclosed cylinder that is 60-90% filled with a viscous fluid for dynamically changing the center of gravity of the portable airfoil-based payload stabilizer.

4. The portable airfoil payload stabilizer according to claim 2, wherein the tubular shaped handle member comprises an enclosed cylinder that is 60-90% filled with fluid for dynamically changing the buoyancy of the portable airfoil-based payload stabilizer.

5. The portable airfoil payload stabilizer according to claim 1, wherein the swept back, delta-winged airfoil member that has a substantially, elliptical cross section comprising left and right wing portions divided along a center line from a leading edge to a trailing edge; wherein the right and left wing portions have a substantially elliptical cross section wherein the upper surface of the left and right wing portions arc in a convex manner from the leading edge to the trailing edge along the upper surface; and
a substantially elliptical cross section wherein the lower surface of the left- and right-wing portions arc in a convex manner from the leading edge to the trailing edge along the upper surface.

6. The portable airfoil payload stabilizer according to claim 1, wherein the swept back, delta-winged airfoil member that has a substantially, elliptical cross section comprising left- and right-wing portions divided along a center line from a leading edge to a trailing edge; wherein the upper surface of the left- and right-wing portions arc in a convex manner from a leading edge to a trailing edge along the upper surface; and
a substantially elliptical cross section wherein the lower surface of left- and right-wing portions arc in a concave manner from the leading edge to the trailing edge along the upper surface.

7. The portable airfoil payload stabilizer according to claim 3, wherein the tubular handle member can receive additional weight components for adjusting the center of gravity of the portable airfoil payload stabilizer.

8. The portable airfoil payload stabilizer according to claim 1, wherein the upper surface of the left- and right-wing portions arc in a convex manner from a leading edge to a trailing edge along the upper surface; and wherein the convex upper surface of the portable airfoil tapers up and over the convex curve from the centerline and downward 0.5 to 30 degrees creating a “butterfly” orientation of the left- and right-wing portions and toward the rear of the airfoil off to the trailing edge.

9. A portable camera stabilizer, comprising:
a swept back, delta-winged, elliptical cross-section, airfoil member;
the airfoil member having a bottom lower surface with an attached handle receptacle for securing the airfoil member to a proximal end of a handle member;
and a top upper surface of the airfoil member comprising an attached camera mounting receptacle for securing a mounted camera.

10. The portable camera stabilizer according to claim 9, further comprising wherein the tubular handle member further comprises a first grip firmly secured at a distal end of the tubular member and a receptacle attachment at a proximal end of the tubular handle member.

11. The portable camera stabilizer according to claim 9, wherein the delta winged, airfoil member is neutrally buoyant and water submergible.

12. The portable camera stabilizer according to claim 9, wherein the delta winged, airfoil member is positively buoyant and water submergible.

13. The portable camera stabilizer according to claim 9, wherein the bottom lower surface of the delta winged airfoil member arcs from a leading edge to a trailing edge in a substantially conclave fashion.

14. The portable camera stabilizer according to claim 9, wherein the bottom lower surface of the delta winged airfoil member arcs from a leading edge to a trailing edge in a substantially convex fashion.

15. The portable camera stabilizer according to claim 9, wherein the top upper surface of the delta winged airfoil member arcs from a leading edge to a trailing edge in a substantially conclave fashion.

16. The portable camera stabilizer according to claim 9, wherein the top upper surface of the delta winged airfoil member arcs from a leading edge to a trailing edge in a substantially convex fashion.

17. A portable camera stabilizer, comprising:
right and left wings mounted atop a proximal end of respective right and left pillars;
the right and left pillars attached at opposite ends respectively of a linear payload base;
one or more handles mounted along the linear payload base;
and a camera mounting receptacle mounted along the linear payload base for securing a mounted camera.

18. The portable camera stabilizer according to claim 17, wherein the right and left wings have a substantially elliptical cross section wherein the upper surface of the wing arcs in a convex manner from a leading edge to a trailing edge along the upper surface; and
a substantially elliptical cross section wherein the lower surface of the wing arcs in a convex manner from the leading edge to the trailing edge along the upper surface.

19. The portable camera stabilizer according to claim 17, wherein the right and left wings have a substantially elliptical cross section wherein the upper surface of the wing arcs in a convex manner from a leading edge to a trailing edge along the upper surface; and
a substantially elliptical cross section wherein the lower surface of the wing arcs in a concave manner from the leading edge to the trailing edge along the upper surface.

20. The portable camera stabilizer according to claim 17, wherein the handles bracket the left and right sides of the camera mounting receptacle, mounted along the linear payload base for securing a mounted camera.
